(19) United States
(12) Patent Application Publication
(10) Pub. No.: US 2014/0263896 A1
(43) Pub. Date: Sep. 18, 2014

(54) BRACKET AND HOOK ACCESSORIES FOR BOLTLESS SHELVING UNITS

(71) Applicant: RAPID RACK INDUSTRIES,INC., City of Industry, CA (US)

(72) Inventors: Dan A. David, La Canada Flintridge, CA (US); Harry R. Taylor, Whittier, CA (US); Robert S. Chow, Diamond Bar, CA (US)

(21) Appl. No.: 13/802,057

(22) Filed: Mar. 13, 2013

(51) Int. Cl. F16M 13/02

(52) U.S. Cl. CPC F16M 13/022
USPC 248/207

(57) ABSTRACT

Bracket and hook accessories configured to be detachably connected to a shelving unit having a plurality of openings are provided. In one embodiment, the bracket includes a body portion having a front surface, a rear surface, and an upper edge, at least one interlocking member extending rearward from the rear surface of the body portion, the at least one interlocking member configured to engage at least one of the plurality of openings to detachably connect the bracket to the shelving unit, and at least two rearwardly turned flanges spaced apart by a distance along the upper edge of the body portion, the rearwardly turned flanges configured to detachably connect the bracket to the shelving unit such that the bracket is slidably positionable along the shelving unit.

### FIELD OF THE INVENTION

The present invention relates generally to bracket and hook accessories configured to be detachably connected to a shelving unit and support a variety of different articles.

### BACKGROUND

Storage racks and shelving units are commonly used to store a variety of different articles, such as tools and equipment in a garage (e.g., drills, brooms, shovels, extension cords, etc.), in an organized and readily accessible manner. Typical storage racks include left and right end support units and front and rear cross beams extending between the end support units. Together, corresponding front and rear cross beams extending between the end support units define a frame configured to support a shelf for storing various articles. Typically, each end support unit includes front and rear vertical support members and cross braces, both horizontal and diagonal, interconnecting the front and rear vertical support members.

One common type of storage rack known in the art is a “boltless” rack, in which at least some of the members of the rack are configured to be assembled without the use of permanent mechanical fasteners. In some conventional boltless racks, the members of the end support units are permanently coupled together, such as by welding or riveting, and the cross beams are detachably connected to the vertical support members of the end support units. Typically, the vertical support posts include a series of apertures, such as wedge-shaped slots or keyhole-shaped openings, configured to detachably receive interconnecting members, such as rivets or lances, on opposite ends of the cross beams. Accordingly, boltless racks are configured to permit easy assembly and disassembly of the storage rack or shelving unit without the use of tools, and to permit compact and economical shipment of the unit. An example of a boltless shelving unit is shown and described in U.S. patent application Ser. No. 13/360,543, entitled “Modular Rack Assembly,” the entire contents of which are hereby incorporated by reference.

The storage capacity of such conventional storage racks and shelving units, however, is limited by the number of shelves and their surface area. Practical considerations, such as the size of the user's workspace, may restrict the user from using a storage rack or shelving unit having larger shelves or a greater number of shelves. Additionally, it may be cumbersome to place certain articles (e.g., brooms, shovels, etc.) on a shelf and certain articles may not be readily accessible once stacked on a shelf. Accordingly, the bracket and hook accessories of the present invention are configured to be releasably attached to the frame of existing boltless storage racks and shelving units, thereby increasing the storage capacity of existing storage racks and shelving units. Additionally, the bracket and hook accessories of the present invention are repositionable along the frame of the storage rack and shelving units, thereby accommodating a variety of articles having different shapes and sizes.

### SUMMARY

The present invention is directed to various bracket and hook accessories configured to be detachably connected to a shelving unit having a plurality of vertical support members, each vertical support member including a plurality of openings, a plurality of braces coupled to the plurality of vertical support members, and a plurality of crossbeams extending between the vertical support members. In one embodiment, the bracket includes a body portion having a front surface, a rear surface, and an upper edge, at least one interlocking member extending rearward from the rear surface of the body portion, the at least one interlocking member configured to engage at least one of the plurality of openings in the vertical support members to detachably connect the bracket to the shelving unit, and at least two rearwardly turned flanges spaced apart by a distance along the upper edge of the body portion, the rearwardly turned flanges configured to engage a portion of one of the plurality of crossbeams to detachably connect the bracket to the shelving unit such that the bracket is slidably positionable along crossbeam. Accordingly, the bracket may be either detachably connected to the vertical support member or, alternatively, to the crossbeam of the shelving unit. In one embodiment, the bracket further includes a plurality of narrow ridges extending forward from the front surface of the body portion. In another embodiment, the distance between the flanges is at least as great as a width of one of the plurality of vertical support members. In yet another embodiment, the bracket includes a tab disposed between the two rearwardly turned flanges, the tab extending upward from an upper edge of the body portion of the bracket. In yet a further embodiment, the body portion of the bracket is generally rectangular. In yet another embodiment, the plurality of narrow ridges comprises a first set of spaced apart narrow ridges and a second set of spaced apart narrow ridges, the first set of narrow ridges at least partially overlapping the second set of narrow ridges.

In one embodiment, the at least one opening in the frame is keyhole-shaped, and each of the at least one interlocking member on the bracket includes a shaft having a first diameter protruding rearward from the body portion, the shaft having an interconnected end coupled to the rear surface of the body portion and a free end opposite the interconnected end, and a head having a second diameter coupled to the free end of the shaft, wherein the second diameter is larger than the first diameter. In another embodiment, the at least one opening in the frame includes a pair of tapered wedge-shaped openings having a wider upper end and a narrower lower end, and each of the at least one interlocking member comprises a pair of lances spaced apart by a distance protruding rearward from the body portion, wherein the distance between the lances is substantially equal to a width of the narrower lower end of the pair of tapered openings, and the pair of lances taper inward such that lower ends of the lances are spaced closer together than upper ends of the lances.

In one embodiment, the bracket includes a bushing coupled to the front surface of the body portion of the bracket, and an S-shaped hook, wherein a portion of the S-shaped hook is rotatably received in the bushing. In another embodiment, the bracket includes a U-shaped hook having a longer leg and a shorter leg, the longer leg coupled to the front surface of the body portion of the bracket. In yet a further embodiment, the bracket includes first and second J-shaped hooks, and a connection coupled to the front surface of the body portion of the bracket, the connection coupling the first and second J-shaped hooks together.

In another embodiment, the bracket includes a body portion having a front surface, a rear surface, an upper edge, and a lower edge, at least one interlocking member extending rearward from the rear surface of the body portion, the at least one interlocking member configured to engage at least one of the plurality of openings in the vertical support members to detachably connect the bracket to the shelving unit, an upper flange extending upward and forward from the upper edge of the body portion, the upper flange having an interconnected end coupled to the body portion and a free end opposite the interconnected end, and a lower flange extending upward and forward from the lower edge of the body portion, the lower flange having an interconnected end coupled to the body portion and a free end opposite the interconnected end. In one embodiment, the upper flange defines an angle with the body portion ranging between approximately 100 degrees and approximately 150 degrees, and the lower flange defines an angle with the body portion ranging between approximately 80 degrees and approximately 30 degrees. In yet another embodiment, the bracket includes an upper lip extending upward from the free end of the upper flange, and a lower lip extending upward from the free end of the lower flange. In one embodiment, the bracket includes an opening in the upper flange.

In one embodiment, the at least one opening in the frame is keyhole-shaped, and each of the at least one interlocking member on the bracket includes a shaft having a first diameter protruding rearward from the body portion, the shaft having an interconnected end coupled to the rear surface of the body portion and a free end opposite the interconnected end, and a head having a second diameter coupled to the free end of the shaft, wherein the second diameter is larger than the first diameter. In another embodiment, the at least one opening in the frame includes a pair of tapered openings having a wider upper end and a narrower lower end, and each of the at least one interlocking member comprises a pair of lances spaced apart by a distance protruding rearward from the body portion, wherein the distance between the lances is substantially equal to a width of the narrower lower end of the pair of tapered openings, and the pair of lances taper inward such that lower ends of the lances are spaced closer together than upper ends of the lances. In one embodiment, the upper flange is narrower than the body portion such that a pair of shoulders is defined on opposite sides of the upper flange, and the lower flange is narrower than the body portion such that a pair of shoulders is defined on opposite sides of the lower flange.

In one embodiment, the bracket is configured to be detachably connected to a shelving unit having a plurality of openings and configured to be coupled by a weld to at least one hook configured to support at least one article. In one embodiment, the bracket includes a body portion having a front surface, a rear surface, and an upper edge, at least one interlocking member extending rearward from the rear surface of the body portion, the at least one interlocking member configured to engage at least one of the plurality of openings in the vertical support members to detachably connect the bracket to the shelving unit, and a plurality of narrow ridges extending forward from the front surface of the body portion, the plurality of narrow ridges configured to increase a load-bearing capacity of the bracket and improve the weld coupling the bracket to the at least one hook. In one embodiment, the at least one hook is selected from the group consisting of an S-shaped hook, a J-shaped hook, and a pair of J-shaped hooks. In another embodiment, the plurality of narrow ridges comprises a first set of spaced apart narrow ridges and a second set of spaced apart narrow ridges, the first set of narrow ridges at least partially overlapping the second set of narrow ridges.

This summary is provided to introduce a selection of concepts that are further described below in the detailed description. This summary is not intended to identify key or essential features of the claimed subject matter, nor is it intended to be used in limiting the scope of the claimed subject matter.

### BRIEF DESCRIPTION OF THE DRAWINGS

Embodiments of a bracket according to the present invention are described with reference to the following figures. The same reference numerals are used throughout the figures to reference like features and components. The figures are not necessarily drawn to scale.

FIG. 1 is a perspective view of a boltless shelving unit/storage rack having two pairs of front and rear vertical support posts each having a plurality of keyhole-shaped openings and two pairs of front and rear cross-beams extending between the vertical support posts and various embodiments of brackets and hooks detachably connected to the shelving unit;

FIGS. 2A and 2B are front and rear perspective views, respectively, of a bracket according to an embodiment of the present invention;

FIG. 2C is a side view of the bracket illustrated in FIGS. 2A and 2B;

FIGS. 2D and 2E are a rear perspective view and a side view, respectively, of another embodiment of a bracket;

FIG. 3 is a front perspective view of the embodiment of the bracket illustrated in FIGS. 2A and 2B having an S-shaped hook assembly rotatably secured thereto;

FIG. 4 is a front perspective view of the embodiment of the bracket illustrated in FIGS. 2A and 2B having a J-shaped hook secured thereto;

FIG. 5 is a front perspective view of the embodiment of the bracket illustrated in FIGS. 2A and 2B having a pair of interconnected J-shaped hooks secured thereto;

FIGS. 6A and 6B are front and rear perspective views, respectively, of a bracket according to another embodiment of the present invention;

FIG. 7 is a perspective view of a boltless shelving unit/storage rack having two pairs of front and rear vertical support posts each having a plurality of wedge-shaped openings and two pairs of front and rear cross-beams, and various embodiments of brackets and hooks detachably connected to the shelving unit;

FIGS. 8A and 8B are front and rear perspective views, respectively, of a bracket according to another embodiment of the present invention;

FIG. 9 is a front perspective view of the embodiment of the bracket illustrated in FIGS. 8A and 8B having an S-shaped hook assembly rotatably secured thereto;

FIG. 10 is a front perspective view of the embodiment of the bracket illustrated in FIGS. 8A and 8B having a J-shaped hook secured thereto;

FIG. 11 is a front perspective view of the embodiment of the bracket illustrated in FIGS. 8A and 8B having a pair of interconnected J-shaped hooks secured thereto;

FIGS. 12A and 12B are front and rear perspective views, respectively, of a bracket according to another embodiment of the present invention; and

FIG. 13 is a flowchart illustrating a method of installing and using the brackets and hooks of the present invention according to one embodiment.

### DETAILED DESCRIPTION

The present invention relates generally to support bracketry, and more particularly to brackets and hooks configured to be detachably connected to a boltless shelving unit. The brackets and hooks are configured to support a variety of difficult articles, such as brooms, shovels, and other tools. The brackets and hooks of the present invention are configured to provide a system for storing a variety of different articles in an organized and readily accessible manner. The brackets and hooks of the present invention are also configured to increase the storage capacity of existing storage racks and shelving units.

With reference to FIG. 1, a boltless shelving unit 10 is illustrated having several different embodiments of brackets and hooks detachably connected thereto, each of which are described in more detail below. In the illustrated embodiment of FIG. 1, the boltless shelving unit 10 includes left and right end support units 11, 12, respectively, interconnected by front and rear crossbeams 13, 14, respectively. Each end support unit 11, 12 includes front and rear vertical support posts 15, 16, respectively, upper and lower horizontal braces 17, 18, respectively, and a diagonal brace 19. Ends of the upper braces 17 are coupled to upper ends of the vertical support posts 15, 16 and ends of the lower braces 18 are coupled to lower ends of the vertical support posts 15, 16. Ends of the diagonal braces 19 are coupled to intermediate portions of the vertical posts 15, 16 between the upper and lower ends of the vertical support posts 15, 16. In an alternate embodiment, the ends of the diagonal braces 19 may be secured to upper and lower ends of the vertical support posts 15, 16 (e.g., one end of the diagonal brace 19 may be coupled to the upper end of the rear vertical support post 16 and the other end of the diagonal brace 19 may be coupled to the lower end of the front vertical support post 15). The upper, lower, and diagonal braces 17, 18, 19 may be coupled to the vertical support posts 15, 16 by any suitable means, such as mechanical fastening or welding.

With continued reference to the embodiment illustrated in FIG. 1, each of the vertical support posts 15, 16 is a beam having an L-shaped transverse cross-section. It will be appreciated, however, that the vertical support posts 15, 16 may have any other suitable shape, such as a U-shaped or Z-shaped transverse cross-section. Additionally, in the illustrated embodiment, each of the vertical support posts 15, 16 includes a plurality of keyhole-shaped openings 20 arranged in two columns. As used herein, the term “plurality” shall mean two or more. Each of the keyhole-shaped openings 20 includes a relatively larger upper circular opening 21 and a relatively smaller circular opening 22 extending downward from a lower end of the larger opening 21. As described in detail below, embodiments of the brackets and hooks of the present invention are configured to be detachably connected to the keyhole openings 20 in the vertical support posts 15, 16.

Still referring to FIG. 1, opposite ends of the front crossbeams 13 are boltlessly coupled to the front vertical support posts 15 and ends of the rear crossbeams 14 are boltless coupled to the rear vertical support posts 16. It will be appreciated that the shelving unit 10 may include any suitable number of crossbeams 13, 14, such as between two and ten. Additionally, the crossbeams 13, 14 may be positioned at any suitable elevation along the vertical support posts 15, 16 depending upon the locations of the keyhole-shaped openings 20 in the vertical support posts 15, 16. In the illustrated embodiment, the crossbeams 13, 14 have an omega-shaped transverse cross-section. The crossbeams 13, 14 each include a pair of spaced apart upper and lower vertical legs 23, 24, respectively. In the illustrated embodiment, opposite ends of the upper and lower vertical legs 23, 24 of each crossbeam 13, 14 include interlocking members 25 configured to releasably engage the keyhole-shaped openings 20 in the vertical support posts 15, 16. The crossbeams 13, 14 each also include an upper horizontal flange 26 extending inward from a lower end of the upper vertical leg 23, a lower horizontal flange 27 extending inward from an upper end of the lower vertical leg 24, and a vertical flange 28 extending between inner ends of the upper and lower horizontal flanges 26, 27. Together, the inwardly extending upper horizontal flanges 26 on the crossbeams 13, 14 define a frame 29 configured to support a shelf panel 30 or other planar support member. As described in detail below, embodiments of the brackets and hooks of the present invention are configured to be detachably connected to the crossbeams 13, 14 and slidably positionable along the upper legs 23 of the crossbeams 13, 14 into any desired lateral position along the boltless shelving unit 10.

With reference now to FIGS. 2A and 2B, an embodiment of a bracket 35 configured to be detachably connected to the shelving unit 10 is illustrated. The bracket 35 is configured to be positionable along both the vertical support posts 15, 16 and the crossbeams 13, 14 of the shelving unit 10. As will be described in more detail below, the bracket 35 is configured to be coupled to various hooks configured to releasably support one or more articles, such as shovels, brooms, or other tools. In the illustrated embodiment, the bracket 35 includes a body portion 36 having a front surface 37 and a rear surface 38 opposite the front surface 37. The rear surface 38 of the bracket 35 is configured to abut a portion of the boltless shelving unit 10 (e.g., the rear surface 38 of the bracket 35 is configured to abut a portion of the vertical support posts 15, 16, as shown in FIG. 1). In the illustrated embodiment, the body portion 36 of the bracket 35 is generally rectangular, although it will be appreciated that the body portion 36 of the bracket 35 may have any other suitable shape, such as circular or square, and still fall within the scope and spirit of the present invention. The bracket 35 also includes a plurality of narrow ridges 39 projecting forward from the front surface 37 of the bracket 35. In one embodiment, the plurality of narrow ridges 39 includes a first set 40 of spaced apart narrow ridges 39 (e.g., three ridges 39 arranged in a first column) and a second set 41 of spaced apart narrow ridges 39 (e.g., three ridges 39 arranged in a second column), wherein the first set 40 of narrow ridges 39 at least partially overlaps the second set 41 of narrow ridges 39. It will be appreciated, however, that the bracket 35 may have any other suitable orientation and number of narrow ridges 39 and still fall within the scope and spirit of the present invention. The plurality of narrow ridges 39 are configured to increase the structural rigidity and load-bearing capacity of the bracket 35. Additionally, the plurality of narrow ridges 39 are configured to improve the weld securing the bracket 35 to the various hooks described below. Moreover, depending upon the manufacturing method of the bracket 35 (e.g., stamping or pressing), the bracket 35 may also include a plurality of recesses 42 in the rear surface 38 that correspond to the narrow ridges 39 on the front surface 37. In an alternate embodiment, the bracket 35 may be provided without the plurality of narrow ridges 39.

With reference now to FIGS. 2B and 2C, the bracket 35 also includes at least one interlocking member configured to detachably engage the keyhole-shaped openings 20 in the vertical support posts 15, 16 of the shelving unit 10. In the illustrated embodiment, the bracket 35 includes upper and lower interlocking members 43, 44, respectively, although the bracket 35 may include any other suitable number of interlocking members 43, 44, such as between one and four, depending upon the desired load-bearing capacity of the bracket 35 and the article(s) the bracket 35 is configured to support. The spacing between the interlocking members 43, 44 on the bracket 35 corresponds to the spacing between the keyhole-shaped openings 20 in the shelving unit 10 (i.e., the interlocking members 43, 44 on the brackets 35 are spaced to align with the keyhole openings 20 in the shelving unit 10). In the illustrated embodiment, the interlocking members 43, 44 are rivets having a shaft portion 45 projecting rearward from the rear surface 38 of the bracket 35. The shaft portion 45 includes an interconnected end 46 coupled to the rear surface 38 of the bracket 35 and a free end 47 opposite the interconnected end 46. The interlocking members 43, 44 also include a head portion 48 coupled to the free end 47 of the shaft portion 45. In the illustrated embodiment, the head portions 48 of the interlocking members 43, 44 each have an outer diameter larger than the outer diameter of the shaft portion 45. Additionally, it will be appreciated that the outer diameter of the head portions 48 is smaller than the larger circular opening 21 in the keyhole openings 20 in the vertical support posts 15, 16 such that the head portions 48 of the interlocking members 43, 44 may be inserted in the keyhole openings 20. Moreover, the outer diameter of the shaft portion 45 is smaller than the smaller circular opening 22 in the keyhole openings 20 such that the interlocking members 43, 44 can be selectively slid down into small circular openings 22, and the outer diameter of the head portion 48 is larger than the smaller opening portion 22 of the keyhole openings 20 such that the interlocking members 43, 44 are retained in the keyhole openings 20 in the vertical support posts 15, 16.

Still referring to the embodiment depicted in FIGS. 2A-2C, the bracket 35 also includes a tab 50 projecting upward from an upper edge 51 of the rectangular body portion 36. The tab 50 is co-planar with the body portion 36 of the bracket 35 and is also centered along a longitudinal centerline of the body portion 36. In the illustrated embodiment, the tab 50 supports the upper interlocking member 43 (i.e., the shaft portion 45 of the upper interlocking member 43 projects rearward from the rear surface 38 of the tab 50). In the illustrated embodiment, the tab 50 is generally rectangular with rounded upper corners 52, although the tab 50 may have any other suitable shape (e.g., triangular, semi-circular, etc.) and still fall within the scope and spirit of the present invention. The significance of the tab 50 and the position of the upper interlocking member 43 on the tab 50 are described in detail below.

With continued reference to the embodiment illustrated in FIGS. 2A-2B, the bracket 35 also includes a pair of rearwardly turned flanges 53, 54 along the upper edge 51 of the body portion 36 (i.e., the pair of flanges 53, 54 extend rearward and downward from the upper edge 51 of the body portion 36 of the bracket 35). The flanges 53, 54 are configured to detachably connect the bracket 35 to one of the crossbeams 13, 14 of the boltless shelving unit 10. In the illustrated embodiment, the flanges 53, 54 are disposed on opposite sides of the tab 50. Each finger 53, 54 includes an upper arcuate end 55 connected to the upper edge 51 of the body portion 36 and a free lower end 56 extending down along at least a portion of the body portion 36 of the bracket 35. The inwardly turned flanges 53, 54 define inverted U-shaped grooves or channels 57 having open lower ends 58 extending up into the channels 57. As illustrated in FIG. 1, the channels 57 are configured to receive a portion of the upper leg 23 of one of the crossbeams 13, 14 to detachably connect the bracket 35 to the desired crossbeam 13, 14 of the shelving unit 10. When the bracket 35 is detachably connected to the desired crossbeam 13, 14, the flanges 53, 54 overhang at least a portion of the upper leg 23 of the crossbeam 13, 14 to retain the bracket 35 on the crossbeam 13, 14. As illustrated in FIGS. 2D and 2E, the flanges 53, 54 may be configured to attach the bracket 35 to crossbeams 13, 14 having a variety of different cross-sectional shapes, such as C-shaped, Z-shaped, or any other suitable shape. In FIG. 2E, the bracket 35 is illustrated detachably connected to a C-shaped crossbeam 13, 14 having upper and lower horizontal flanges 72, 73, respectively, and a vertical flange 74 extending between front ends of the upper and lower horizontal flanges 72, 73. The flanges 53, 54 are configured to extend over and behind the upper horizontal flange 72 of the crossbeam 13, 14, thereby attaching the bracket 35 to the crossbeam 13, 14. In particular, the flanges 53, 54 illustrated in FIGS. 2D and 2E are spaced farther apart from the body portion 36 of the bracket 35, thereby defining a relatively larger channel 57 configured to receive the upper horizontal flange 72 and a portion of the vertical flange 74 of the crossbeam 13, 14. Additionally, the rear surface 38 of the body portion 36 of the bracket 35 is configured to abut the vertical flange 74 on the crossbeam 13, 14. The abutment between the body portion 36 of the bracket 35 and the vertical flange 74 of the crossbeam 13, 14 is configured to prevent the bracket 35 from rocking back and forth when detachably connected to the crossbeam 13, 14, which might otherwise cause the bracket 35 to inadvertently detach from the crossbeam 13, 14.

Referring again to FIGS. 2A-2C, the tab 50 on the bracket 35 extends sufficiently above the flanges 53, 54 such that at least a portion of the upper interlocking member 43 on the tab 50 is spaced above the upper arcuate ends 55 of the flanges 53, 54. In one embodiment, the upper interlocking member 43 is positioned on the tab 50 such that the head portion 48 of the upper interlocking member 43 is spaced above the upper arcuate ends 55 of the flanges 53, 54. In an alternate embodiment, the upper interlocking member 43 may be positioned on the tab 50 such that a portion of the head portion 48 of the upper interconnecting member 43 extends below the upper arcuate ends 55 of the flanges 53, 54. Positioning a portion of the head portion 48 of the upper interlocking member 43 below the upper arcuate ends 55 of the flanges 53, 54 configures the upper interlocking member 43 to overhang a portion of the upper leg 23 of the crossbeam 13, 14 when the bracket 35 is detachably connected to the crossbeam 13, 14. In this embodiment, the upper interlocking member 43 cooperates with the two flanges 53, 54 to attach the bracket 35 to the crossbeam 13, 14 (i.e., together, the upper interlocking member 43 and the two flanges 53, 54 provide three points of attachment between the bracket 35 and the crossbeam 13, 14). In either embodiment, the upper interlocking member 43 is positioned on the tab 50 such that the shaft portion 45 of the upper interlocking member 43 is spaced above or in line with the upper arcuate ends 55 of the flanges 53, 54. Otherwise, the shaft portion 45 of the upper interlocking member 43 may contact the upper leg 23 of the crossbeam 13, 14 before the upper leg 23 is completely received in the channels 57 of the flanges 53, 54, thereby preventing proper engagement between the flanges 53, 54 and the crossbeam 13, 14 (i.e., the tab 50 is configured to position the upper interlocking member 43 such that the shaft portion 45 of the upper interlocking member 43 does not contact the upper leg 23 of the crossbeam 13, 14 before the upper leg 23 of the crossbeam 13, 14 is fully received in the channels 57 of the flanges 53, 54).

Based upon the foregoing description, it will be appreciated that the bracket 35 is configured to be positionable along both the vertical support posts 15, 16 and the horizontal crossbeams 13, 14 of the boltless shelving unit 10. Specifically, the upper and lower interlocking members 43, 44 are configured to detachably connect the bracket 35 to the keyhole-shaped openings 20 in the vertical support posts 15, 16 of the shelving unit 10 and the flanges 53, 54 are configured to detachably and slidably connect the bracket 35 to the crossbeams 13, 14 of the shelving unit 10.

The bracket 35 may be formed from any suitable process, such as stamping, pressing, machining, molding, or rapid prototyping using additive manufacturing. In one embodiment, the interlocking members 43, 44 are welded to the rear surface 38 of the body portion 36. The bracket 35 may be made of any suitably strong and durable material, such as aluminum alloy, steel, plastic (e.g., polyvinyl chloride (PVC) or polypropylene (PP)), or carbon fiber reinforced plastic.

With reference now to the embodiments illustrated in FIGS. 3-5, the bracket 35 is configured to support a variety of different hooks of the present invention. In the embodiment illustrated in FIG. 3, the bracket 35 is configured to support an S-shaped hook assembly 60. The S-shaped hook assembly 60 includes an S-shaped hook 61 and a bushing 62. The S-shaped hook 61 includes upper and lower horizontal legs 63, 64, respectively, an intermediate horizontal leg 65 disposed between the upper and lower horizontal legs 63, 64, a vertical leg 66 interconnecting the upper and intermediate legs 63, 65, and an arcuate portion 67 interconnecting the intermediate and lower legs 65, 64. The lower horizontal leg 64 is configured to support various article(s), such as tools. In the illustrated embodiment, both the intermediate and lower horizontal legs 65, 64 and the arcuate portion 67 have a larger outer diameter than the vertical leg 66 and upper horizontal leg 63. In one embodiment, the lower and intermediate horizontal legs 64, 65 and the arcuate portion 67 of the S-shaped hook 61 may be made out of a material dissimilar to the material of the vertical and upper horizontal legs 66, 63. For instance, the lower and intermediate legs 64, 65 and the arcuate portion 67 may be made out of plastic and the vertical and upper horizontal legs 66, 63 may be made out of a weldable metal, such as steel. Alternatively, the horizontal legs 63, 64, 65, the vertical leg 66, and the arcuate portion 67 may be made out of similar materials. In one embodiment, the horizontal legs 63, 64, 65, the vertical leg 66, and the arcuate portion 67 of the S-shaped hook 61 are all made of metal, but the lower and intermediate horizontal legs 64, 65 and the arcuate portion 67 are coated with an elastomeric material, such as rubber.

With continued reference to FIG. 3, the bushing 62 is a cylindrical tube having an outer diameter and an inner diameter. The inner diameter of the cylindrical bushing 62 is defined by a smooth bore 68 extending the entire length of the bushing 62. At least a portion of the upper horizontal leg 63 of the S-shaped hook 61 is rotatably received in the smooth bore 68 of the bushing 62 such that the S-shaped hook 61 is configured to rotate (arrow 69) approximately 180° (i.e., the S-shaped hook 61 is configured to rotate approximately 180° between a down position, shown in solid lines in FIG. 3, and an up position, shown in dashed lines in FIG. 3).

The bushing 62 may be coupled to the front surface 37 of the bracket 35 by any suitable means, such as bonding, welding, or mechanical fastening. The S-shaped hook 61 may be coupled to the bushing 62 by any suitable means. In one embodiment, an end portion 70 of the upper horizontal leg 63 of the S-shaped hook 61 extends completely through the bore 68 in the bushing 62. In the illustrated embodiment, a sleeve 71 is coupled to the end portion 70 of the S-shaped hook 61 extending through the bushing 62, such as by bonding, welding, or crimping, to prevent the S-shaped hook 61 from inadvertently disengaging the bushing 62. In an alternate embodiment, the S-shaped hook 61 may be secured to the bushing 62 by a cotter pin extending through an opening in the end portion 70 of the upper horizontal leg 63 of the S-shaped hook 61 extending completely through the bore 68 in the bushing 62.

Although in the embodiment of the bracket 35 and S-shaped hook assembly 60 illustrated in FIG. 3 the bushing 62 is coupled to the bracket 35 in a horizontal orientation, the bushing 62 may be coupled to the bracket 35 in any other suitable orientation (e.g., vertical or canted at an angle of approximately 45°), depending upon the article(s) (e.g., a broom, a shovel) that the S-shaped hook assembly 60 is configured to support.

With reference now to the embodiment illustrated in FIG. 4, the bracket 35 is configured to support a J-shaped hook 75. The J-shaped hook 75 includes a shorter vertical leg 76, a longer vertical leg 77 configured to be coupled to the bracket 35, and a lower arcuate portion 78 connecting the vertical legs 76, 77. The lower arcuate portion 78 is configured to support various article(s), such as tools. It will be appreciated that the shorter vertical leg 76 defines a lip configured to retain the various article(s) supported by the lower arcuate portion 78 of the J-shaped hook 75. In the illustrated embodiment, both the shorter leg 76 and the lower arcuate portion 78 have a larger outer diameter than the longer leg 77. In one embodiment, the shorter leg 76 and the lower arcuate portion 78 of the J-shaped hook 75 may be made out of a material dissimilar to the material of the longer leg 77 (e.g., the shorter leg 76 and the lower arcuate portion 78 may be made out of plastic and the longer leg 77 may be made out of a weldable metal, such as steel). Alternatively, the shorter leg 76, the longer leg 77, and the lower arcuate portion 78 may be made out of similar materials. In one embodiment, the legs 76, 77 and the arcuate portion 78 of the J-shaped hook 75 are all made of metal, but the shorter leg 76 and the arcuate portion 78 are coated with an elastomeric material, such as rubber. Additionally, the longer vertical leg 77 includes a kink 79 configured to space the lower arcuate portion 78 and the shorter vertical leg 76 away from the front surface 37 of the bracket 35. Accordingly, the kink 79 in the longer leg 77 is configured to accommodate the larger diameter of the lower arcuate portion 78 of the J-shaped hook 75. The longer leg 77 of the J-shaped hook 75 may be coupled to the front surface 37 of the bracket 35 by any suitable means, such as bonding, adhering, fastening, or welding.

With reference now to the embodiment illustrated in FIG. 5, the bracket 35 is configured to support a hook assembly 80. In the illustrated embodiment, the hook assembly 80 includes a pair of J-shaped hooks 75, substantially as described above, and a horizontal connector 81 extending between upper ends 82, 83 of the longer legs 77 to couple the pair of J-shaped hooks 75 together. The longer legs 77 of the J-shaped hooks 75 and the horizontal connector 81 may be coupled to the front surface 37 of the bracket 35 by any suitable means, such as bonding, adhering, fastening, or welding.

With reference now to FIGS. 6A and 6B, another embodiment of a bracket 85 configured to be detachably connected to the boltless shelving unit 10 is illustrated. In the illustrated embodiment, the bracket 85 includes a generally rectangular body portion 86 having a front and rear surfaces 87, 88, respectively, and upper and lower edges 89, 90, respectively. The bracket 85 also includes a pair of upper and lower rivet interlocking members 91, 92 projecting from the rear surface 88 of the body portion 86. Each interlocking member 91, 92 includes a shaft portion projecting rearward from the rear surface 88 of the bracket 85 and a head portion 93 coupled to a free end of the shaft portion, substantially as described above with reference to FIG. 2B. The pair of rivet interlocking members 91, 92 is configured to detachably connect the bracket 85 to two of the keyhole-shaped openings 20 in the vertical supports 15, 16 of the shelving unit 10. In the illustrated embodiment, the bracket 85 includes two interlocking members 91, 92, although the bracket 85 may include any other suitable number of interlocking members 91, 92, such as between one and four, depending upon the desired load-bearing capacity of the bracket 85 and the article(s) the bracket 85 is configured to support.

With continued reference to FIGS. 6A and 6B, the bracket 85 also includes an upper flange 95 extending forward and upward from the upper edge 89 of the body portion 86. The upper flange 95 includes an interconnected end 96 connected to the body portion 86 of the bracket 85 and a free end 97 opposite the interconnected end 96. In the illustrated embodiment, the upper flange 95 defines an obtuse angle α with the body portion 86, such as between approximately 100 degrees and approximately 150 degrees. In an alternate embodiment, the upper flange 95 may define any other suitable angle α with the body portion 86 (e.g., the upper flange 95 may extend generally orthogonally from the body portion 86). The bracket 85 also includes a lip 98 extending upward from the free end 97 of the upper flange 95. In one embodiment, the bracket 85 also includes an opening 104 (e.g., a hole) in the upper flange 95.

With continued reference to FIGS. 6A and 6B, the bracket 85 also includes a lower flange 99 extending forward and upward from the lower edge 90 of the body portion 86. The lower flange 99 includes an interconnected end 100 connected to the body portion 86 of the bracket 85 and a free end 101 opposite the interconnected end 100. In the illustrated embodiment, the lower flange 99 defines an acute angle β with the body portion 86, such as between approximately 60 degrees and approximately 15 degrees. In an alternate embodiment, the lower flange 99 may define any other suitable angle β with the body portion 86 (e.g., the lower flange 99 may extend generally orthogonally from the body portion 86). The bracket 85 also includes a lip 102 extending upward from the free end 101 of the lower flange 99.

The upper and lower flanges 95, 99 on the bracket 85 are configured to support a variety of different article(s), such as tools, in an organized and readily accessible manner. It will be appreciated that the lower flange 99 and the body portion 86 define a J-shaped hook configured to support various articles. Additionally, flexible articles, such as extension cords, cables, and ropes may be repeatedly wound around the upper and lower flanges 95, 99 into organized and readily accessible spool. Moreover, when a pair of brackets 85 are detachably connected to vertical support posts 15 on opposite end support units 11, 12, as shown in FIG. 1, the pair of brackets 85 are configured support relatively long articles, such as brooms and shovels (e.g., the handle end of the shovel may be supported by the bracket 85 on the left end support unit 11 and the blade end of the shovel may be support by the bracket 85 on the right end support unit 12 of the shelving unit 10).

The lips 98, 102 on the free ends 97, 101 of the flanges 95, 99, respectively, protect the user during attachment and removal of the various article(s) from the bracket 85. Otherwise, the free ends 97, 101 of the relatively thin flanges 95, 99 may form a sharp edge against which the user could inadvertently cut his hand. Additionally, the sharp edges on the free ends 97, 101 of the flanges 95, 99 could damage (e.g., fray) the articles stored on the bracket 85. Moreover, the lips 98, 102 are configured to retain the various article(s) supported by the bracket 85 (i.e., the lips 98, 102 are configured to prevent the article(s) from inadvertently disengaging the bracket 85). It will be appreciated that the free ends 97, 101 of the flanges 95, 99 could have other configurations, such as being provided without lips 98, 102, and still fall within the scope and spirit of the present invention.

With reference now to the embodiment illustrated in FIG. 7, another embodiment of a boltless shelving unit 110 is illustrated. Substantially as described above, the boltless shelving unit 110 includes left and right end support units 111, 112 interconnected by front and rear crossbeams 113, 114 configured to support one or more shelves 120. In the illustrated embodiment, each end support unit 111, 112 includes front and rear vertical support posts 115, 116, respectively, upper and lower horizontal braces 117, 118, respectively, and a diagonal brace 119. The upper, lower, and diagonal braces 117, 118, 119 may be coupled to the vertical support posts 115, 116 by any suitable means, such as mechanical fastening or welding.

With continued reference to the embodiment illustrated in FIG. 7, each of the vertical support posts 115, 116 is a beam or channel having a flat outer plate 121 and two flanges 122, 123 extending inward from opposite sides of the flat outer plate 121. Together, the flat outer plate 121 and the flanges 122, 123 define a beam having a generally U-shaped transverse cross-section. It will be appreciated, however, that the vertical support posts 115, 116 may have any other suitable shape, such as an L-shaped or Z-shaped transverse cross-section.

Additionally, in the illustrated embodiment of FIG. 7, each of the flat outer plates 121 of the vertical support posts 115, 116 includes a plurality of wedge-shaped openings 125, 126 arranged in two columns. Each wedge-shaped opening 125, 126 includes a relatively larger upper end 127 which tapers to a relatively narrower lower end 128. Additionally, each wedge-shaped opening 125 in one of the columns has a corresponding wedge-shaped opening 126 in the other column. Together, the corresponding wedge-shaped openings 125, 126 define a pair of wedge-shaped openings. For each pair of wedge-shaped openings, the lower ends 128 of the wedge-shaped openings 125, 126 are angled towards each other (i.e., the upper ends 127 of the openings 125, 126 are spaced farther apart than the lower ends 128 of the openings 125, 126).

Embodiments of the brackets and hooks of the present invention are configured to be detachably connected the wedge-shaped openings 125, 126 in the vertical support posts 115, 116. The boltless shelving unit 110 is illustrated in FIG. 7 with several different embodiments of brackets and hooks detachably connected thereto, each of which are described in more detail below.

With continued reference to FIG. 7, opposite ends of the front crossbeams 113 are boltlessly coupled to the front vertical support posts 115 of the left and right end support units 111, 112 and opposite ends of the rear crossbeams 114 are boltlessly coupled to the rear vertical support posts 116 of the left and right end support units 111, 112. It will be appreciated that the shelving unit 110 may include any suitable number of crossbeams 113, 114, such as between two and ten. Additionally, the crossbeams 113, 114 may be positioned at any suitable elevation along the vertical support posts 115, 116 depending upon the locations of the wedge-shaped openings 125, 126 in the vertical support posts 115, 116. Each end of the crossbeams 113, 114 includes a pair of interlocking members 130 configured to releasably engage one of the pairs of wedge-shaped openings 125, 126 in the vertical support posts 115, 116.

Referring now to FIGS. 8A and 8B, an embodiment of a bracket 135 configured to be detachably connected to the shelving unit 110 is illustrated. Substantially as described above with reference to FIGS. 3-5, the bracket 135 is configured to be coupled to the S-shaped hook assembly 60 (see FIG. 9), the J-shaped hook 75 (see FIG. 10), and the hook assembly 80 having a pair of J-shaped hooks 75 (see FIG. 11) to support one or more articles, such as shovels, brooms, and other tools and equipment, in an organized and readily accessible manner.

In the illustrated embodiment of FIGS. 8A and 8B, the bracket 135 includes a body portion 136 having a front surface 137 and a rear surface 138 opposite the front surface 137. The rear surface 138 of the bracket 135 is configured to abut the flat outer plates 121 of the vertical support posts 115, 116, as illustrated in FIG. 7. In the illustrated embodiment, the body portion 136 of the bracket 135 is generally rectangular, although it will be appreciated that the body portion 136 of the bracket 135 may have any other suitable shape, such as circular or square, and still fall within the scope and spirit of the present invention. The bracket 135 also includes a plurality of narrow ridges 139 projecting forward from the front surface 137 of the bracket 135. In one embodiment, the plurality of narrow ridges 139 includes a first set 140 of spaced apart narrow ridges 139 (e.g., three ridges 139 arranged in a first column) and a second set 141 of spaced apart narrow ridges 139 (e.g., three ridges 139 arranged in a second column), wherein the first set 140 of narrow ridges 139 at least partially overlaps the second set 141 of narrow ridges 139. It will be appreciated, however, that the bracket 135 may have any other suitable orientation and number of narrow ridges 139 and still fall within the scope and spirit of the present invention. The plurality of narrow ridges 139 are configured to increase the structural rigidity and load-bearing capacity of the bracket 135. Additionally, in one embodiment, the plurality of narrow ridges 139 are configured to improve the weld securing one of the hooks 60, 75, 80 (see FIGS. 9-11) to the bracket 135. Moreover, depending upon the manufacturing method of the bracket 135 (e.g., stamping or pressing), the bracket 135 may also include a plurality of recesses 142 in the rear surface 138 that correspond to the narrow ridges 139 on the front surface 137. In an alternate embodiment, the bracket 135 may be provided without the plurality of narrow ridges 139 and recesses 142.

With continued reference to FIGS. 8A and 8B, the bracket 135 also includes a pair of interlocking members 143, 144 configured to detachably engage one of the pairs of wedge-shaped openings 125, 126 in the vertical support posts 115, 116 of the shelving unit 110. In the illustrated embodiment, the bracket 135 includes a single pair of interlocking members 143, 144, although the bracket 135 may include any other suitable number of interlocking members 143, 144, such as two pairs of interlocking members, depending upon several factors, such as the desired load-bearing capacity of the bracket and the nature of the article(s) the bracket 135 is configured to support. In the illustrated embodiment, the interlocking members 143, 144 are hooks or lances. Each lance interlocking member 143, 144 includes a tab 145 projecting rearward from the rear surface 138 of the body portion 136. The tab 145 includes an interconnected end 146 coupled to the rear surface 138 of the bracket 135 and a free end 147 opposite the interconnected end 146. Each lance 143, 144 also includes an outwardly turned flange 148 extending from the free end 147 of the tab 145 (i.e., the flanges 148 on the pair of lance interlocking members 143, 144 extend in opposite directions).

With continued reference to FIG. 8B, the opposing lance interlocking members 143, 144 are angled towards each other at an angle generally corresponding to the angle at which the wedge-shaped openings 125, 126 in the vertical support posts 115, 116 are tapered towards each other. Additionally, the spacing between the lance interlocking members 143, 144 on the bracket 135 is smaller than the spacing between the upper ends 127 of wedge-shaped openings 125, 126 in the vertical support posts 115, 116 such that the lances 143, 144 may be inserted into the wedge-shaped openings 125, 126. Moreover, the spacing between the lances 143, 144 is slightly larger than the spacing between the lower ends 128 of the wedge-shaped openings 125, 126 in the vertical support posts 115, 116 such that when the bracket 135 is slid down toward the lower ends 128 of the wedge-shaped openings 125, 126, the lance interlocking members 143, 144 are compressed towards each other and thereby retained in the wedge-shaped openings 125, 126. Additionally, when the bracket 135 is detachably connected to the boltless shelving unit 110, the flanges 148 on the interlocking members 143, 144 overhang a portion of the vertical support posts 115, 116, thereby securing the bracket 135 to the shelving unit 110.

With reference now to FIGS. 12A and 12B, another embodiment of a bracket 150 configured to be detachably connected to the boltless shelving unit 110 is illustrated. The bracket 150 includes a body portion 151 having a front surface 152 and a rear surface 153 opposite the front surface 152. The rear surface of the bracket 150 is configured to abut the flat outer plate 121 of the vertical support posts 115, 116, as illustrated in FIG. 7. In the illustrated embodiment, the body portion 151 of the bracket 150 is rectangular, although it will be appreciated that the body portion 151 of the bracket 150 may have any other suitable shape, such as circular or square, and still fall within the scope and spirit of the present invention. With continued reference to FIGS. 12A and 12B, the bracket 150 also includes a pair of lance interlocking member 154, 155, substantially as described above with reference to bracket 135, configured to detachably engage one of the pairs of wedge-shaped openings 125, 126 in the vertical support posts 115, 116 of the shelving unit 110. In the illustrated embodiment, the bracket 150 includes a single pair of lance interlocking members 154, 155, although the bracket 150 may include any other suitable number of lance interlocking members 154, 155, such as two pairs of interlocking members, depending upon several factors, such as the desired load-bearing capacity of the bracket 150 and the nature of the article(s) the bracket 150 is configured to support.

The bracket 150 also includes an upper flange 156 extending forward and upward from an upper edge 157 of the body portion 151. The upper flange 156 includes an interconnected end 158 connected to the body portion 151 of the bracket 150 and a free end 159 opposite the interconnected end 158. In the illustrated embodiment of FIG. 12A, the upper flange 156 defines an obtuse angle θ with the body portion 151, such as between approximately 100 degrees and approximately 150 degrees. In an alternate embodiment, the upper flange 156 may define any other suitable angle θ with the body portion 151 (e.g., the upper flange 156 may extend generally orthogonally from the body portion 151). The bracket 150 also includes a lip 160 extending upward from the free end 159 of the upper flange 156. In the illustrated embodiment, the upper flange 156 is narrower than the rectangular body portion 151 such that a pair of shoulders 161, 162 is defined on opposite sides of the upper flange 156. In one embodiment, the bracket 150 also includes an opening 173 (e.g., a hole) in the upper flange 156.

With continued reference to FIG. 12A, the bracket 150 also includes a lower tab 163 extending downward from a lower edge 164 of the body portion 151. In the illustrated embodiment, the lower tab 163 is co-planar with the body portion 151 of the bracket 150. The lower tab 163 includes an interconnected end 165 connected to the body portion 151 of the bracket 150 and a free end 166 opposite the interconnected end 165. The bracket 150 also includes a lower flange 167 extending forward and upward from free end 166 of the lower tab 163. The lower flange 167 includes an interconnected end 168 connected to the free end 166 of the lower tab 163 and a free end 169 opposite the interconnected end 168. In the illustrated embodiment, the lower flange 167 defines an acute angle μ with the body portion 151, such as between approximately 80 degrees and approximately 30 degrees. In an alternate embodiment, the lower flange 167 may define any other suitable angle μ with the body portion 151 (e.g., the lower flange 167 may extend orthogonally from the body portion 151). The bracket 150 also includes a lip 170 extending upward from the free end 169 of the lower flange 167. In the illustrated embodiment, the upper and lower flanges 156, 167 are substantially parallel, although in other embodiments the upper and lower flanges 156, 167 may not be parallel. Additionally, in the illustrated embodiment, the lower flange 167 and the lower tab 163 are narrower than the rectangular body portion 151 such that a pair of shoulders 171, 172 is defined on opposite sides of the lower tab 163. The bracket 150 is configured to support a variety of articles, such as extension cords, cables, ropes, brooms, shovels, and other tools.

With reference now to the flowchart illustrated in FIG. 13, a method 200 of installing and using the embodiments of the brackets 35, 85, 135, 150 and/or hooks 60, 75, 80 of the present invention to increase the storage of a boltless shelving unit 10, 110 will be described. In one embodiment, the method 200 includes a task 205 of selecting an appropriate bracket 35, 85, 135, 150 depending upon the type of boltless storage rack 10, 110. To increase the storage capacity of a boltless storage rack 10 having a plurality of keyhole-shaped openings 20 in the vertical support posts 15, 16, the method 200 includes a task 210 of selecting a bracket 35, 85 having at least one rivet interlocking member 43, 44 (or 91, 92) configured to detachably engage one or more of the keyhole-shaped openings 20. To increase the storage capacity of a boltless storage 110 rack having a plurality of wedge-shaped openings 125, 126 in the vertical support posts 115, 116, the method 200 includes a task 215 of selecting a bracket 135, 150 having at least one pair of lance interlocking members 143, 144 (or 154, 155) configured to detachably engage at least one pair of the wedge-shaped openings 125, 126. Additionally, the method 200 may include a task 220 of selecting a bracket 35 having a pair of flanges 53, 54 configured to detachably engage the upper leg 23 of one of the crossbeams 13, 14 on the shelving unit 10. It will be appreciated that the task 205 of selecting a bracket 35, 85, 135, 150 includes selecting the appropriate number and type of brackets 35, 85, 135, 150 based upon the number and type of article(s) the user desires to arrange on the boltless shelving unit 10, 110.

The method 200 may also include a task 225 of selecting a hook 60, 75, 80 having the desired configuration based upon the article(s) the user desires to store and arrange on the boltless shelving unit 10, 110. The task 225 of selecting the desired hook 60, 75, 80 may include selecting a bracket 35, 135 having a J-shaped hook 75 secured thereto, selecting a bracket 35, 135 having an S-shaped hook assembly 60 rotatably secured thereto, or selecting a bracket 35, 135 having a hook assembly 80 secured thereto.

With continued reference to the flowchart illustrated in FIG. 13, the method 200 also includes a task 230 of selecting the desired locations of the brackets 35, 85, 135, 150 and/or hooks 60, 75, 80 along the boltless shelving unit 10, 110 (i.e., selecting the desired elevations of the brackets 35, 85, 135, 150 along the vertical support posts 15, 16 (or 115, 116) and/or the desired lateral positions of the brackets 35 along the horizontal crossbeams 13, 14). The desired positions of the brackets 35, 85, 135, 150 and/or hooks 60, 75, 80 on the shelving unit 10, 110 may be based upon several factors, including the nature of the article(s) the user intends to support on the bracket 35, 85, 135, 150 and/or hooks 60, 75, 80 (e.g., a broom or shovel) and the desired accessibility of the article(s).

The method 200 also includes a task 235 of detachably connecting the brackets 35, 85, 135, 150 and/or hooks 60, 75, 80 to the desired locations along the shelving unit 10, 110. To attach the brackets 35, 85, 135, 150 to the keyhole openings 20 in the vertical support posts 15, 16 of the boltless shelving unit 10, the method 200 includes a task 240 of inserting the head portions 48 (or 93) of the rivet interlocking members 43, 44 (or 91, 92) into the larger, upper end 21 of the desired keyhole openings 20, and a task 245 of translating the bracket 35, 85, 135, 150 downward until the head portion 48 (or 93) of the rivet interlocking members 43, 44 (or 91, 92) are aligned with the smaller, lower end 22 of the keyhole openings 20. To attach the brackets 35 to the crossbeams 13, 14, the method 200 includes a task 250 of hooking the flanges 53, 54 on the bracket 35 over the upper leg 23 on the desired crossbeam 13, 14 and a task 255 of sliding the bracket 35 along the crossbeam 13, 14 into the desired lateral position along the shelving unit 10.

To attach the brackets 135, 150 to the wedge-shaped openings 125, 126 in the vertical support posts 115, 116 of the boltless shelving unit 110, the method 200 includes a task 260 of inserting the at least one pair of lance interlocking members 143, 144 (or 154, 155) on the bracket 135, 150 into the upper end 127 of the desired pair of wedge-shaped openings 125, 126 in the vertical support posts 115, 116, and a task 265 of translating the bracket 135, 150 downward toward the lower end 128 of the pair of wedge-shaped openings 125, 126. As the bracket 135, 150 is translated downward, the lances 143, 144 (or 154, 155) are compressed toward each other by the angled wedge-shaped openings 125, 126, thereby detachably securing the bracket 135, 150 to the shelving unit 110. Additionally, when the bracket 135, 150 is attached to the shelving unit 110, the outwardly turned flanges 148 on the lances 143, 144 (or 154, 155) overlap a portion of the vertical support posts 115, 116 to secure the bracket 135, 150 to the shelving unit 110.

The method 200 also includes a task 270 of attaching the desired article(s) (e.g., brooms or shovels) to the brackets 35, 85, 135, 150 and/or hooks 60, 75, 80. To detach the brackets 35, 85, 135, 150 and/or hooks 60, 75, 80 from the shelving unit 10, 110, the aforementioned tasks are performed in reverse.

While in one embodiment, the method 200 of installing and using the brackets 35, 85, 135, 150 and/or hooks 60, 75, 80 may include each of the tasks described above and shown in FIG. 13, in other embodiments of the present invention, one or more of the tasks described above and shown in FIG. 13 may be absent and/or additional tasks may be performed. Furthermore, in the method 200 of installing and using the brackets 35, 85, 135, 150 and/or hooks 60, 75, 80 according to one embodiment, the tasks may be performed in the order depicted in FIG. 13. However, the present invention is not limited thereto and, in a method of installing and using the brackets 35, 85, 135, 150 and/or hooks 60, 75, 80 according to other embodiments of the present invention, the tasks described above and shown in FIG. 13 may be performed in any other suitable sequence. For example, in one embodiment, the task 235 of detachably connecting the brackets 35, 85, 135, 150 and/or hooks 60, 75, 80 to the desired locations along the shelving unit 10, 110 is performed before the task 270 of attaching the desired article(s) (e.g., brooms or shovels) to the brackets 35, 85, 135, 150 and/or hooks 60, 75, 80, while in an alternate embodiment, the task 270 of attaching the desired article(s) to the brackets 35, 85, 135, 150 and/or hooks 60, 75, 80 is performed before the task 235 of detachably connecting the 35, 85, 135, 150 and/or hooks 60, 75, 80 to the desired locations along the shelving unit 10, 110.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims. Although relative terms such as “outer,” “inner,” “upper,” “lower,” “below,” “above,” “vertical, “horizontal” and similar terms have been used herein to describe a spatial relationship of one element to another, it is understood that these terms are intended to encompass different orientations of the various elements and components of the device in addition to the orientation depicted in the figures.

What is claimed is:

1. A bracket configured to be selectively connected to a vertical support member of a shelving unit or a crossbeam of a shelving unit, the bracket comprising:
a body portion having a front surface, a rear surface, and an upper edge;
at least one interlocking member extending rearward from the rear surface of the body portion, the at least one interlocking member configured to engage at least one of a plurality of openings in the vertical support member for detachably connecting the bracket to the shelving unit; and
at least two rearwardly turned flanges spaced apart by a distance along the upper edge of the body portion, the rearwardly turned flanges configured to engage a portion of the crossbeam for detachably connecting the bracket to the shelving unit such that the bracket is slidably positionable along the crossbeam.

2. The bracket of claim 1, further comprising a plurality of narrow ridges extending forward from the front surface of the body portion.

3. The bracket of claim 1, wherein the distance between the flanges is at least as great as a width of the vertical support member.

4. The bracket of claim 1, further comprising a tab disposed between the two rearwardly turned flanges, the tab extending upward from an upper edge of the body portion of the bracket.

5. The bracket of claim 1, wherein the body portion of the bracket is generally rectangular.

6. The bracket of claim 1, wherein:
each of the plurality of openings in the vertical support member is keyhole-shaped; and
each of the at least one interlocking member on the bracket comprises:
a shaft having a first diameter protruding rearward from the body portion, the shaft having an interconnected end coupled to the rear surface of the body portion and a free end opposite the interconnected end; and
a head having a second diameter coupled to the free end of the shaft, wherein the second diameter is larger than the first diameter.

7. The bracket of claim 1, wherein:
each of the plurality of openings in the vertical support member comprises a pair of tapered openings having a wider upper end and a narrower lower end; and
each of the at least one interlocking member on the bracket comprises a pair of lances spaced apart by a distance protruding rearward from the body portion,
wherein:
the distance between the lances is substantially equal to a width of the narrower lower end of the pair of tapered openings, and
the pair of lances taper inward such that lower ends of the lances are spaced closer together than upper ends of the lances.

8. The bracket of claim 2, wherein the plurality of narrow ridges comprises a first set of spaced apart narrow ridges and a second set of spaced apart narrow ridges, the first set of narrow ridges at least partially overlapping the second set of narrow ridges.

9. The bracket of claim 1, further comprising:
a bushing coupled to the front surface of the body portion of the bracket; and
an S-shaped hook, wherein a portion of the S-shaped hook is rotatably received in the bushing.

10. The bracket of claim 1, further comprising a U-shaped hook having a longer leg and a shorter leg, the longer leg coupled to the front surface of the body portion of the bracket.

11. The bracket of claim 1, further comprising:
first and second J-shaped hooks; and
a connection rod coupled to the front surface of the body portion of the bracket, the connection rod coupling the first and second J-shaped hooks together.

12. A bracket configured to support at least one article and configured to be detachably connected to a vertical support member of a shelving unit, the bracket comprising:
a body portion having a front surface, a rear surface, an upper edge, and a lower edge;
at least one interlocking member extending rearward from the rear surface of the body portion, the at least one interlocking member configured to engage at least one of a plurality of openings in the vertical support member to detachably connect the bracket to the shelving unit;
an upper flange extending upward and forward from the upper edge of the body portion, the upper flange having an interconnected end coupled to the body portion and a free end opposite the interconnected end; and
a lower flange extending upward and forward from the lower edge of the body portion, the lower flange having an interconnected end coupled to the body portion and a free end opposite the interconnected end.

13. The bracket of claim 12, wherein:
the upper flange defines an angle with the body portion ranging between approximately 100 degrees and approximately 150 degrees; and
the lower flange defines an angle with the body portion ranging between approximately 80 degrees and approximately 30 degrees.

14. The bracket of claim 12, further comprising:
an upper lip extending upward from the free end of the upper flange; and
a lower lip extending upward from the free end of the lower flange.

15. The bracket of claim 12, further comprising an opening in the upper flange.

16. The bracket of claim 12, wherein:
each of the plurality of openings in the vertical support member is keyhole-shaped; and
each of the at least one interlocking member on the bracket comprises:
a shaft having a first diameter protruding rearward from the body portion, the shaft having an interconnected end coupled to the rear surface of the body portion and a free end opposite the interconnected end; and
a head having a second diameter coupled to the free end of the shaft, wherein the second diameter is larger than the first diameter.

17. The bracket of claim 12, wherein:
each of the plurality of openings in the vertical support member comprises a pair of tapered openings having a wider upper end and a narrower lower end; and
each of the at least one interlocking member on the bracket comprises a pair of lances spaced apart by a distance protruding rearward from the body portion,
wherein:
the distance between the lances is substantially equal to a width of the narrower lower end of the pair of tapered openings, and
the pair of lances taper inward such that lower ends of the lances are spaced closer together than upper ends of the lances.

18. The bracket of claim 12, wherein:
the upper flange is narrower than the body portion such that a pair of shoulders is defined on opposite sides of the upper flange; and
the lower flange is narrower than the body portion such that a pair of shoulders is defined on opposite sides of the lower flange.

19. A bracket configured to be detachably connected to a vertical support member of a shelving unit and configured to be coupled by a weld to at least one hook configured to support at least one article, the bracket comprising:
a body portion having a front surface, a rear surface, and an upper edge;
at least one interlocking member extending rearward from the rear surface of the body portion, the at least one interlocking member configured to engage at least one of a plurality of openings in the vertical support member to detachably connect the bracket to the shelving unit; and
a plurality of narrow ridges extending forward from the front surface of the body portion, the plurality of narrow ridges configured to increase a load-bearing capacity of the bracket and improve the weld coupling the bracket to the at least one hook.

20. The bracket of claim 19, wherein the at least one hook is selected from the group consisting of an S-shaped hook, a J-shaped hook, and a pair of J-shaped hooks.

21. The bracket of claim 19, wherein the plurality of narrow ridges comprises a first set of spaced apart narrow ridges and a second set of spaced apart narrow ridges, the first set of narrow ridges at least partially overlapping the second set of narrow ridges.
